(19) United States
(12) Patent Application Publication
(10) Pub. No.: US 2018/0039383 A1
(43) Pub. Date: Feb. 8, 2018

(54) EFFICIENT INFORMATION BROWSING AND MANAGEMENT FLOW

(71) Applicant: INTERNATIONAL BUSINESS MACHINES CORPORATION, Armonk, NY (US)

(72) Inventors: Li-Ju Chen, Taipei City (TW); Ching-Wei Cheng, New Taipei City (TW); Yu-Chun Lin, Taipei (TW); Joey H.Y. Tseng, Taipei (TW); Hsieh-Lung Yang, Taipei City (TW)

(21) Appl. No.: 15/226,750

(22) Filed: Aug. 2, 2016

(51) Int. Cl. G06F 3/0482; G06F 17/30

(52) U.S. Cl. CPC G06F 3/0482; G06F 17/30867; G06F 17/30528; G06F 17/30554

(57) ABSTRACT

A method and system are provided for browsing. The method includes receiving a selection by a user of a particular summary entry from a set of summary entries displayed by an information hub. Each of the summary entries is a respective summary of a respective detailed entry from a set of detailed entries accessible from different ones of a plurality of destination applications. The method further includes generating, by a hardware processor, metadata information about related detailed entries to the particular information summary entry selected by the user. The method also includes generating a custom view for a display device. The custom view includes the respective detailed entry for the particular information summary selected by the user and suggestions of related detailed entries determined from the set of detailed entries using the metadata information.

### BACKGROUND

### Technical Field

The present invention relates generally to information processing and, in particular, to efficient information browsing and management flow.

### Description of the Related Art

Consider the case when a user receives a large number of information entries from different destination applications. Generally, the user performs a quick scan of all of the information entries, and clicks the most interesting one to be brought to the application in order to see the details of that entry. Then we leave the application and choose the next most interesting entry to see. While this behavior looks natural, in fact, it is to be noted that a lot of time is spent prioritizing and filtering information and going back and forth between destination applications. Also, the user is unaware of other applications that might include information which is related to the current information entry the user is viewing.

### SUMMARY

According to an aspect of the present principles, a method is provided for browsing. The method includes receiving a selection by a user of a particular summary entry from a set of summary entries displayed by an information hub. Each of the summary entries is a respective summary of a respective detailed entry from a set of detailed entries accessible from different ones of a plurality of destination applications. The method further includes generating, by a hardware processor, metadata information about related detailed entries to the particular information summary entry selected by the user. The method also includes generating a custom view for a display device. The custom view includes the respective detailed entry for the particular information summary selected by the user and suggestions of related detailed entries determined from the set of detailed entries using the metadata information.

According to another aspect of the present principles, a computer program product is provided for browsing. The computer program product includes a computer readable storage medium having program instructions embodied therewith. The program instructions are executable by a computer to cause the computer to perform a method. The method includes receiving a selection by a user of a particular summary entry from a set of summary entries displayed by an information hub. Each of the summary entries is a respective summary of a respective detailed entry from a set of detailed entries accessible from different ones of a plurality of destination applications. The method further includes generating, by a hardware processor, metadata information about related detailed entries to the particular information summary entry selected by the user. The method additionally includes generating a custom view for a display device. The custom view includes the respective detailed entry for the particular information summary selected by the user and suggestions of related detailed entries determined from the set of detailed entries using the metadata information.

According to yet another aspect of the present principles, a system is provided for browsing. The system includes a computing device, having a processor, a memory, and a display device. The computing device is configured to receive a selection by a user of a particular summary entry from a set of summary entries displayed by an information hub. Each of the summary entries is a respective summary of a respective detailed entry from a set of detailed entries accessible from different ones of a plurality of destination applications. The computing device is further configured to generate metadata information about related detailed entries to the particular information summary entry selected by the user. The computing device is also configured to generate a custom view for the display device. The custom view includes the respective detailed entry for the particular information summary selected by the user and suggestions of related detailed entries determined from the set of detailed entries using the metadata information.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system to which the present principles may be applied, in accordance with an embodiment of the present principles;

FIG. 2 shows an exemplary system for efficient information browsing and management flow, in accordance with an embodiment of the present principles;

FIG. 3 shows an exemplary operating architecture for efficient information browsing and management flow, in accordance with an embodiment of the present principles;

FIGS. 4-5 show an exemplary method for efficient information browsing and management flow, in accordance with an embodiment of the present principles;

FIG. 6 shows an exemplary cloud computing environment, in accordance with an embodiment of the present principles; and

FIG. 7 shows an exemplary set of functional abstraction layers provided by the cloud computing environment shown in FIG. 6, in accordance with an embodiment of the present principles.

### DETAILED DESCRIPTION

The present principles are directed to efficient information browsing and management flow.

The present principles provide a smooth and intelligent flow for information reading or browsing from an information hub such as, for example, but not limited to, a notification center.

In an embodiment, when a user clicks on a certain entry in the information hub to view the detail of that entry in the destination application, the context engine of the information hub will generate metadata related to that selected entry (based on criteria like time range and/or content similarity, and so forth). The metadata along with the selected entry will allow the destination application to show multiple entries that the user might be interested in at the same time (by composing a special view to display all these entries) and those entries might include information from other destination applications, which can be accessed directly from the current application being used. Also, real-time user interaction with the current application (e.g., what entries are actually read and what are not) can be fed back to the context engine to provide more relevant entries for the user to navigate or read next. In this way, the user can read all information related to a certain topic in a more efficient and smooth manner without the interruption caused by the need to go back and forth from and to the information hub to get detailed information that interests the user.

Thus, as an example, consider a notification center found in most modern operations systems. In an embodiment, the present principles would involve providing a dynamic notification viewing flow let users view notifications from different destination applications more easily without jumping back and forth between destination applications. The mechanism can learn the user's behavior of viewing notifications to provide the related notifications link dynamically. Once the user clicks a notification and is brought to the destination application, then the related notifications from other destination applications will be provided to the user. Then, the user simply clicks the related notifications and is brought to the other destination applications. Users can navigate different destination applications and view related notifications consecutively.

The users do not have to filter the notifications by themselves and spend time navigating all of the destination applications. Moreover, the mechanism can determine the next notification user may interest if he already viewed all notifications of specific interest area.

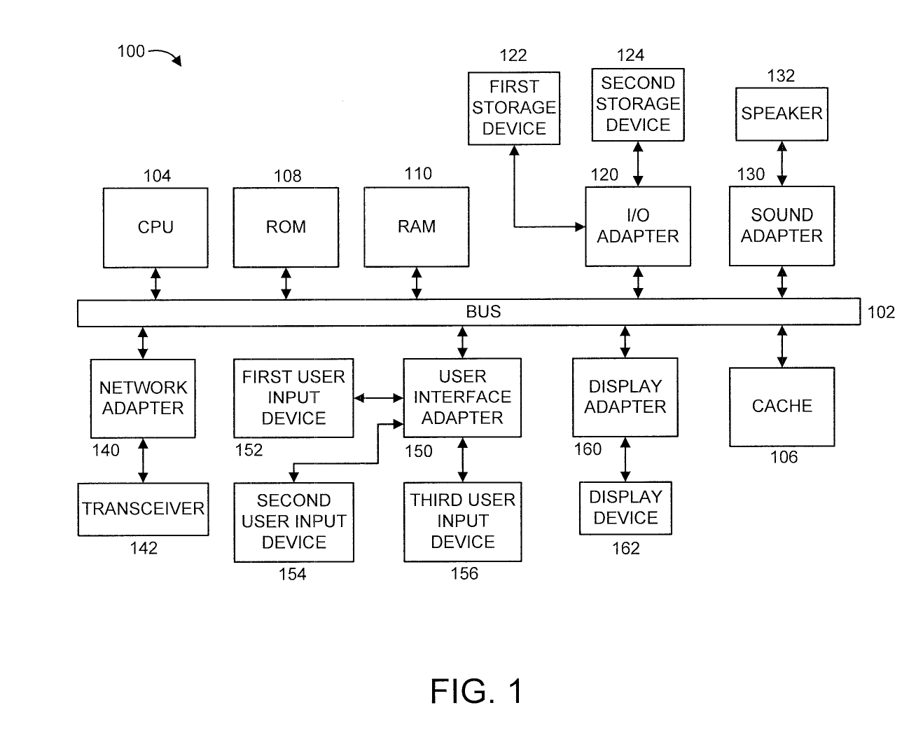

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

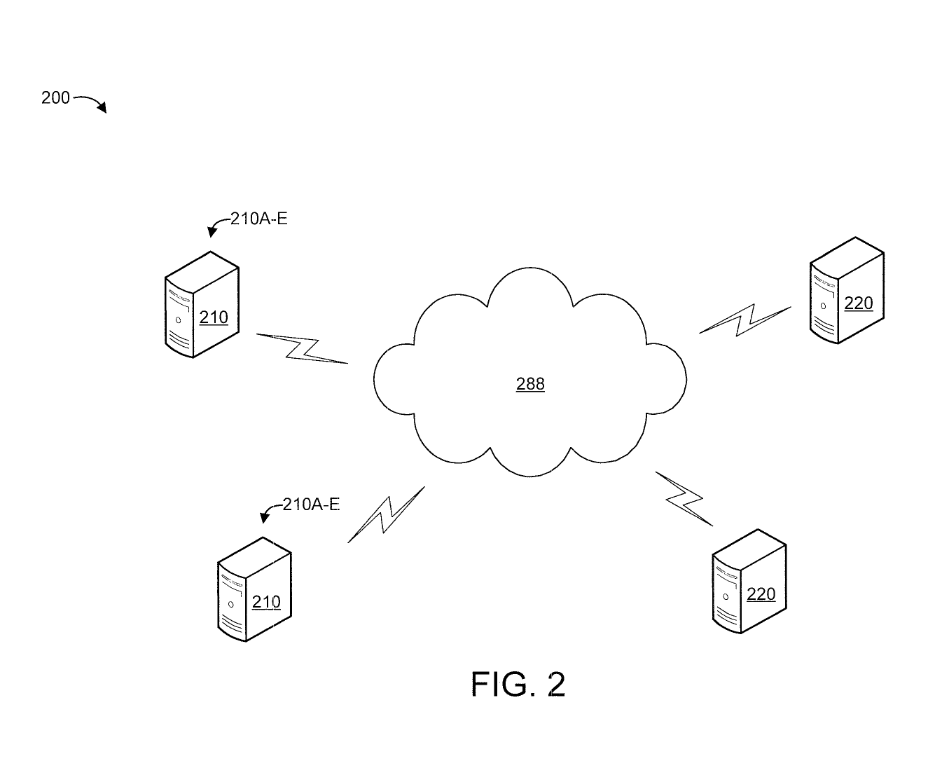

Moreover, it is to be appreciated that system 200 described below with respect to FIG. 2 is a system for implementing respective embodiments of the present principles. Part or all of processing system 100 may be implemented in one or more of the elements of system 200.

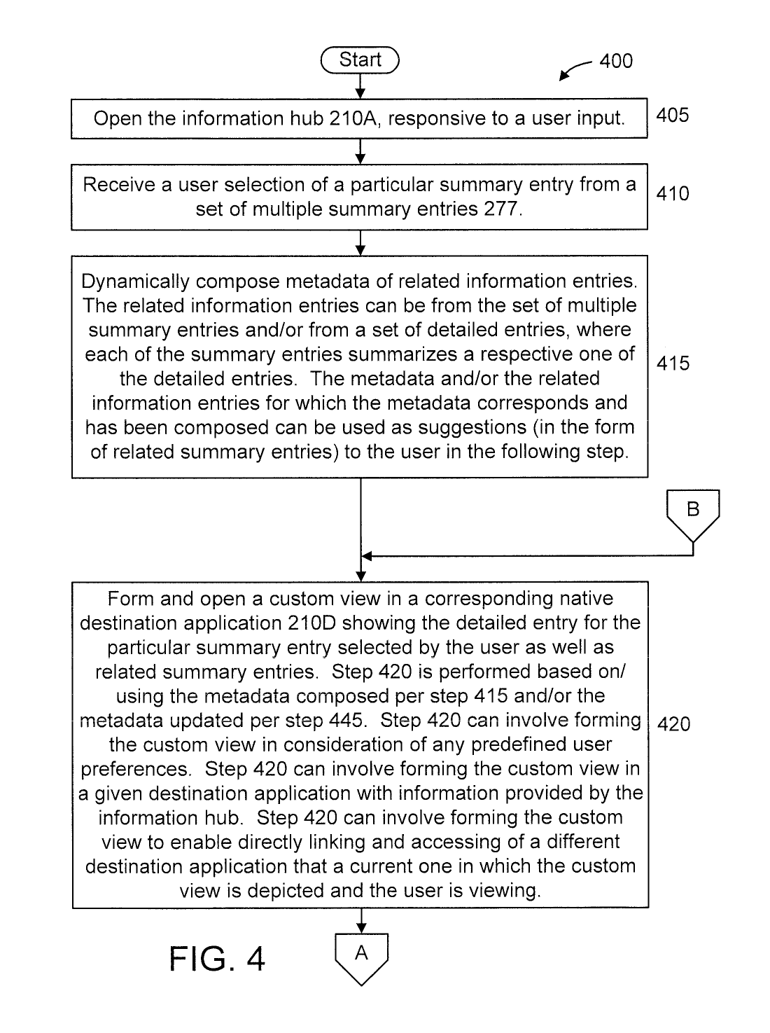

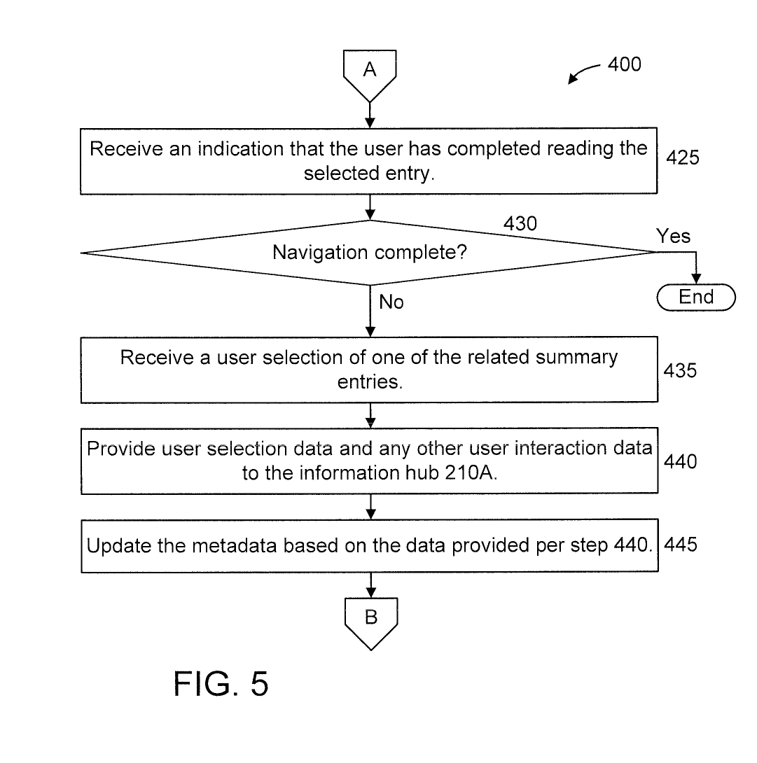

Further, it is to be appreciated that processing system 100 may perform at least part of the method described herein including, for example, at least part of method 400 of FIGS. 4-5. Similarly, part or all of system 200 may be used to perform at least part of method 400 of FIGS. 4-5.

FIG. 2 shows an exemplary system 200 for efficient information browsing and management flow, in accordance with an embodiment of the present principles.

The system 200 includes a set of computing devices (collectively and individually denoted by the figure reference numeral 210). The computing devices 210 can be any type of computing device capable of storing summarized information entries and corresponding links to the full versions of the summarized information entries, as well as capable of reproducing/providing the full versions of the summarized information to a user through one or more destination applications. Thus, the computing devices 210 can be, but are not limited to, servers, desktop computers, mobile computers, smart telephones, media players, tablets, laptops, and so forth.

Each of the computing devices 210 can include an information hub 210A, a content engine 210B, an application agent 210C, destination applications 210D, and custom views 210E. These elements (210A, 210B, 210C, 210D, and 210E) of the computing devices 210 are described in further detail herein below.

In an embodiment, the computing devices 210 can access information on a set of remote servers (collectively and individually denoted by the figure reference numeral 220). The exchange of information between the set of computing devices 210 and/or between the set of computing devices 210 and the set of remote servers 220 can occur over one or more networks (collectively denoted by the figure reference numeral 288). The one or more networks 288 can include any type of networks such as, for example, but not limited to, cellular networks, local area networks, wide area networks, personal area networks, wireless networks, wired networks, any combination of the preceding, and so forth. In the embodiment of FIG. 2, the one or more networks 288 are implemented by one or more wireless networks for the sake of illustration.

In the embodiment shown in FIG. 2, the elements thereof are interconnected by network(s) 288. However, in other embodiments, other types of connections can also be used. Moreover, one or more elements of FIG. 2 can be implemented in a cloud configuration including, for example, in a distributed configuration. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of system 200 are readily determined by one of ordinary skill in the art, given the teachings of the present principles provided herein, while maintaining the spirit of the present principles.

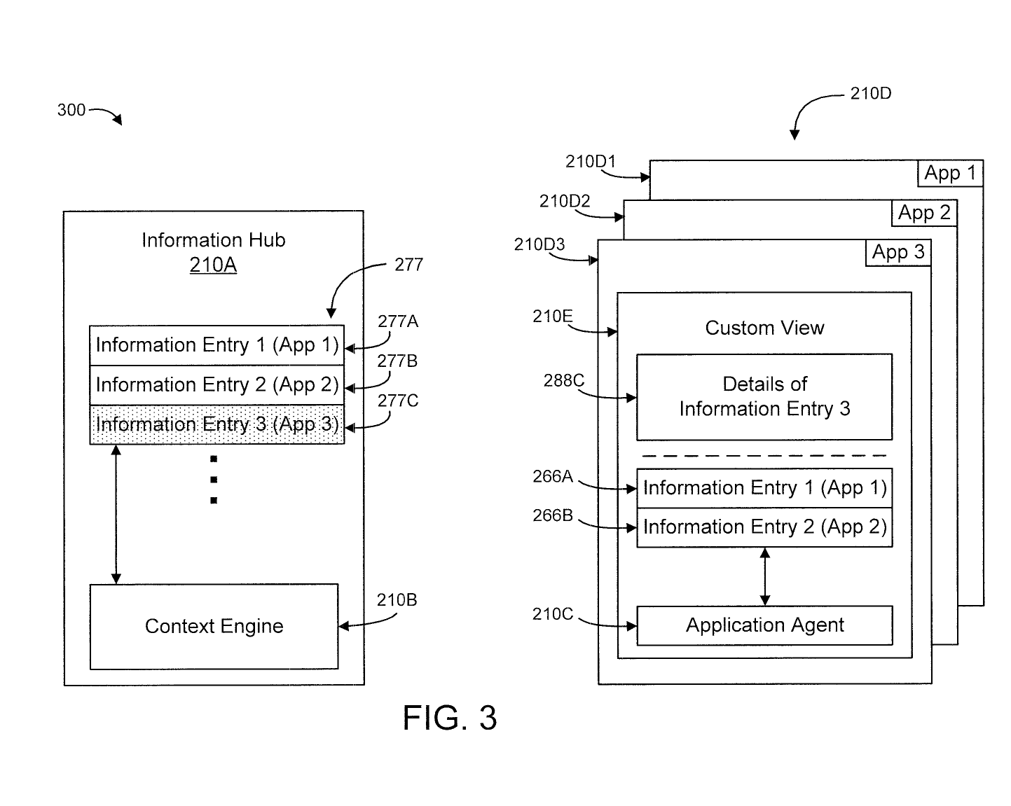

FIG. 3 shows an exemplary operating architecture 300 for efficient information browsing and management flow, in accordance with an embodiment of the present principles.

The operating architecture 300 can reside in a single computing device or across multiple computing devices including devices 210 and 220 of FIG. 2.

The operating architecture 300 includes an information hub 210A, a content engine 210B, application agents 210C, destination applications 210D, and custom views 210E. In an embodiment, each of the destination applications 210D includes a respective one of the application agents 210C.

The information hub 210A is a centralized place that includes summarized information entries (hereinafter interchangeably referred to as “summary entries” in short) and corresponding links to the full versions (hereinafter interchangeably referred to as “detailed entries” in short) of these entries, where the full versions of these entries are resident in the destination applications 210D. That is, the terms “summarized information entries” and “summary entries” refer to summarized versions of content, while in contrast the terms “full versions” and “detailed entries” refer to more complete versions of the content. Thus, as an example, a summary entry may refer to a book title and a chapter title of that book, while a detailed entry corresponding to that summary entry may include the aforementioned titles as well as the full text of the particular chapter. The preceding is merely but one of a myriad of possible examples to which the present principles can be applied. In the embodiment of FIG. 2, the summary entries themselves function as the links to the full versions. Thus, the user simply clicks on a summary entry to be automatically redirected to the full version of that summary entry.

In FIG. 3, the summary entries in the information hub 210A are collectively denoted by the figure reference numeral 277 and individually denoted by figure reference numerals 277A, 277B, and 277C. Information entry 277C is highlighted using a dotted hatch pattern to show a user selection of the same.

In an embodiment, the information hub 210A can be implemented, for example, by the Notification Center application commonly seen in modern operating systems. Of course, other implementations of an information hub can also be used in accordance with the teachings of the present principles, while maintaining the spirit of the present principles.

Each of the destination applications 210D holds the complete content of respective information that interests the user. In the example of FIG. 3, the destination applications 210D include destination applications 210D1, 210D2, and 210D3.

A summary entry in the information hub 210A would redirect the user to the corresponding one of the destination applications 210D for a full version of the information for that summary entry. Thus, clicking on summary entry 277A would redirect the user to destination application 210D1, while clicking on summary entry 277B would redirect the user to destination application 210D2, and clicking on summary entry 277C would redirect the user to destination application 210D3.

Moreover, a summary entry in the custom view 210E of a destination application would redirect the user to one of the destination applications 210D for a full version of the information for that entry. Thus, clicking on summary entry 266B would redirect the user to destination application 210D2, while clicking on summary entry 266A would redirect the user to destination application 210D1.

In an embodiment, summary entries such as 277A and 266A can be the similar in content and function, and may simply differ in where they appear (e.g., 277A is on the information hub, while 266A is on the destination application 210D1). In another embodiment, summary entries such as 277A and 266A can differ. For example, more specific or different content can be provided in the summary on a destination application versus on the information hub. These and other variations of the present principles are readily contemplated by one of ordinary skill in the art given the teachings of the present principles provided herein, while maintaining the spirit of the present principles.

The context engine 210B can be an analytics engine that can dynamically compose the metadata of related information entries as suggestion to the user based on one or more of the following: (1) the currently selected entry by the user; (2) its knowledge about the context of all summary entries in the information hub; (3) feedback from the destination applications about what information entries are selected therein; and (4) any predefined user preference specified in local and/or remote systems.

The generated metadata will be sent to the corresponding one of the destination applications 210D, for example, in response to the user clicking a summary entry whose full version is resident on the corresponding one of the destination applications 210D. The application agent 210C in the corresponding one of the destination applications 210D can then populate the custom view 210E with the full content of the user-selected entry as well as related summary entries provided as suggestions to the user.

The application agent 210C in each supported destination application 210D can perform the following: (1) receive the metadata composed by the context engine 210B about information entries related to the user-selected entry and show those entries as links of summarized information in the custom view 210E (with the destination application specific look-and-feel); (2) gather the current user behavior (e.g., what entry is selected by the user to read next) and feedback to the context engine 210B for metadata generation.

The custom view 210E is a view that is composed dynamically and that includes the full version 288C of content of the user-selected entry 277C and related entry links 266A, 266B based on the metadata generated by the context engine 210B. The custom view 210E for destination application 210D3 includes a full version 288C of summary entry 277C for the sake of illustration.

FIGS. 4-5 show an exemplary method 400 for efficient information browsing and management flow, in accordance with an embodiment of the present principles.

At step 405, open the information hub 210A, responsive to a user input.

At step 410, receive a user selection (e.g., a click) of a particular information summary entry (hereinafter “particular summary entry” in short) (e.g., entry 277A) from a set of multiple information summary entries (hereinafter “set of multiple summary entries” in short) 277.

At step 415, dynamically compose metadata of related information entries. The related information entries can be from the set of multiple summary entries and/or from a set of detailed entries, where each of the summary entries summarizes a respective one of the detailed entries. Different ones of the detailed entries can be accessible through different ones of the destination applications. The metadata and/or the related information entries for which the metadata corresponds and has been composed can be used as suggestions (in the form of related summary entries) to the user in the following step. In an embodiment, step 415 is performed by the context engine 210B.

At step 420, form and open a custom view in a corresponding native destination application 210D showing the detailed entry for the particular summary entry selected by the user (at step 405) as well as related summary entries. Step 420 is performed based on/using the metadata composed per step 415 and/or the metadata updated per step 445. In an embodiment, step 420 can involve forming the custom view in consideration of any predefined user preferences in local and/or remote systems (thus providing an information flow based on user preference). In an embodiment, step 420 can involve forming the custom view in a given destination application with information (e.g., the suggestions) provided by the information hub (e.g., through the application agent for the given destination application). In an embodiment, step 420 can involve forming the custom view to enable directly linking and accessing of a different destination application that a current one in which the custom view is depicted and the user is viewing, thus allowing the user to avoid having to return and go back through the information hub.

At step 425, receive an indication that the user has completed reading the selected entry (e.g., the initially selected particular information entry).

At step 430, determine if the user has completed navigating/using the destination application 210D. If so, then terminate the method. Otherwise, proceed to step 435.

At step 435, receive a user selection of one of the related summary entries (shown to the user in step 420).

At step 440, provide user selection data and any other user interaction data to the information hub 210A.

At step 445, update the metadata based on the data provided per step 440, and return to step 420. In an embodiment, the updating of the metadata is performed by the context engine 210B in the information hub 210A.

A description will now be given regarding an exemplary scenario to which the present principles can be applied, in accordance with an embodiment of the present principles. Of course, the following scenario is provided for illustrative purposes and, thus, the present principles can be readily applied to other scenarios as contemplated by one of ordinary skill in the art given the teachings of the present principles provided herein, while maintaining the spirit of the present principles.

Typically every single day, Bob gets hundreds of messages from different applications of his mobile device. It costs Bob a lot of time to read each message and jump back and forth between the different applications. The messages Bob reads are not organized and in his preferred flow.

As an example, consider the messages in Bob's notification center. Conventionally, Bob has to click each entry in order to enter the corresponding destination application for that entry and obtain/view the corresponding detailed content/information for that entry, and then return to notification center to select the next entry that he is interested in.

In contrast, by using the present principles, clicking one entry will open a view with (1) entry content (2) other entries suggested by the information hub (e.g., by topic). The user can click each entry and view the content in a smooth flow. Also, once the user clicks one of the suggested entries to open it, the selection information will be fed back to information hub. The user can then be presented (in the custom view) with different suggested entries based on information hub calculation results.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

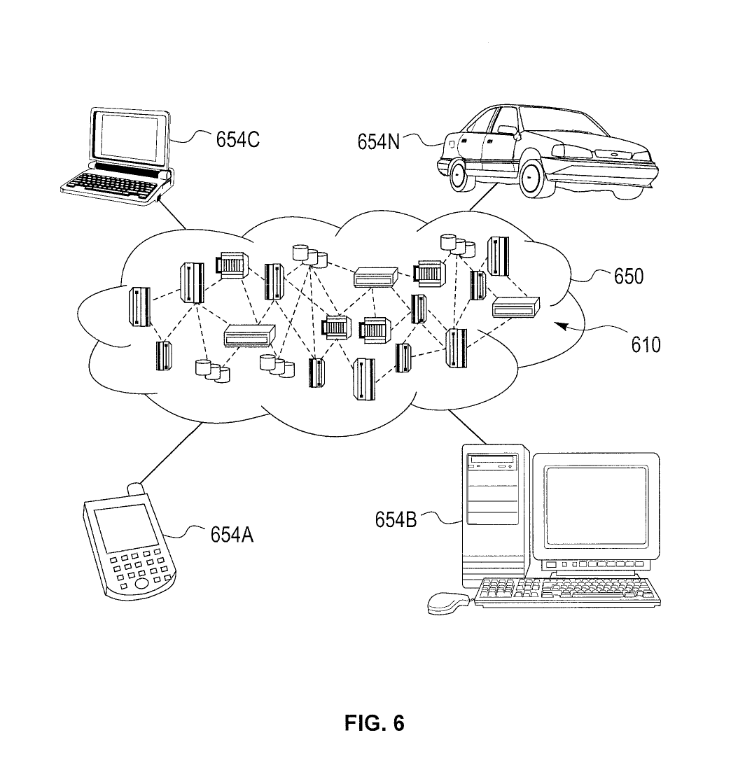

Referring now to FIG. 6, illustrative cloud computing environment 650 is depicted. As shown, cloud computing environment 650 includes one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 6 are intended to be illustrative only and that computing nodes 610 and cloud computing environment 650 can communicate with any type of computerized device over any type of network and/or network addressable connection (e.g., using a web browser).

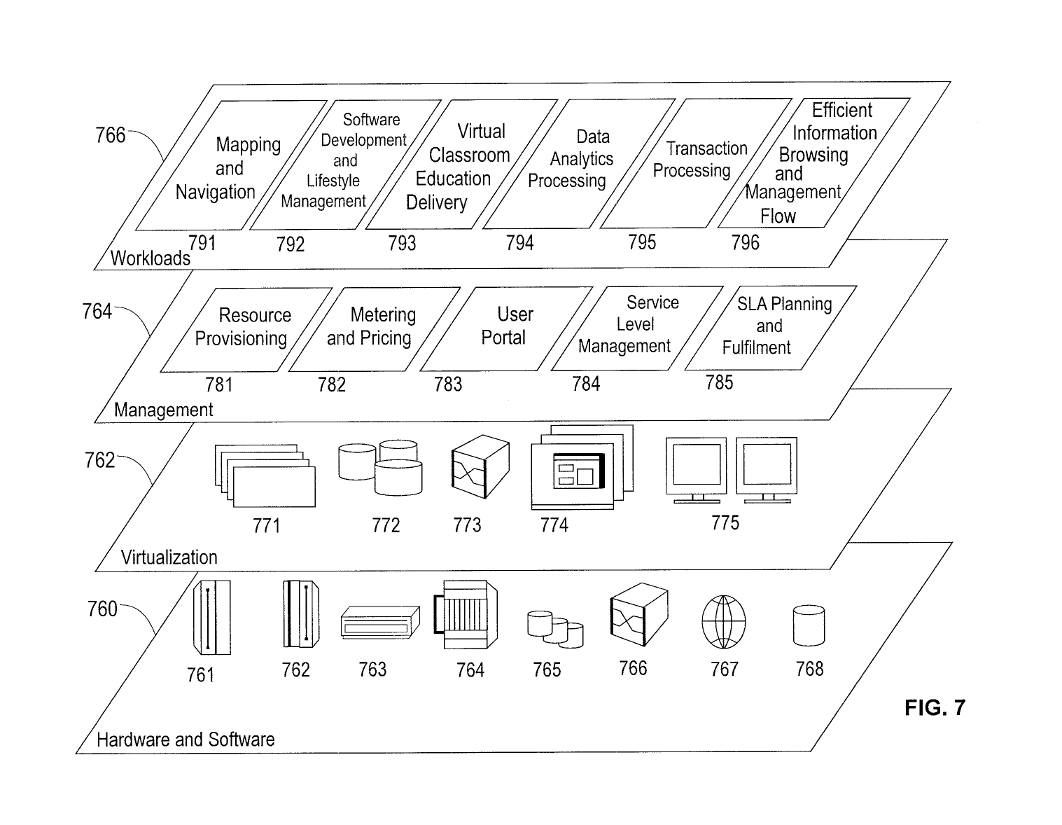

Referring now to FIG. 7, a set of functional abstraction layers provided by cloud computing environment 650 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include: mainframes 761; RISC (Reduced Instruction Set Computer) architecture based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and efficient information browsing and management flow 796.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for browsing, comprising:
receiving a selection by a user of a particular summary entry from a set of summary entries displayed by an information hub, each of the summary entries being a respective summary of a respective detailed entry from a set of detailed entries accessible from different ones of a plurality of destination applications;
generating, by a hardware processor, metadata information about related detailed entries to the particular information summary entry selected by the user; and
generating a custom view for a display device, the custom view including the respective detailed entry for the particular information summary selected by the user and suggestions of related detailed entries determined from the set of detailed entries using the metadata information.

2. The method of claim 1, wherein the information hub is a notification center configured for display on the display device.

3. The method of claim 1, wherein the suggestions of related detailed entries are included in the custom view as respective ones of the summary entries for the related detailed entries.

4. The method of claim 1, wherein the suggestions of related detailed entries comprise at least some of the metadata information determined about the related detailed entries.

5. The method of claim 1, further comprising making the related detailed entries directly accessible to the user through the custom view.

6. The method of claim 5, wherein the custom view is generated for a respective one of the plurality of destination applications

7. The method of claim 5, wherein a given one of the related detailed entries is directly accessible to the user through the custom view, responsive to the user selecting a respective one of the suggestions of the given one of the related detailed entries.

8. The method of claim 1, wherein the related detailed entries are determined based on a comparison of (i) a context of the respective detailed entry for the particular information summary selected by the user to (ii) respective contexts of other ones of the detailed entries accessible from the different ones of the plurality of destination applications.

9. The method of claim 8, wherein the related detailed entries are determined further based on feedback from one or more of the plurality of destination applications.

10. The method of claim 9, wherein the feedback is based on user selection data for the detailed entries.

11. The method of claim 1, further comprising a set of application agents, each of the application agents supporting a respective one of the destination applications by collecting the metadata information for the related detailed entries.

12. The method of claim 11, further comprising a set of application agents, each of the application agents supporting a respective one of the destination applications by further collecting user selection information relating to the detailed entries.

13. The method of claim 1, further comprising dynamically updating the custom view responsive to real-time user interactions relating to the summary entries and the detailed entries.

14. The method of claim 1, wherein at least one of the related detailed entries is sourced from a different one of the plurality of destination applications than the respective detailed entry for the particular information summary selected by the user.

15. The method of claim 14, wherein the at least one of the related detailed entries is directly accessible from the different one of the plurality of destination applications while the user is using a particular one of the destination applications that sources the respective detailed entry for the particular information summary selected by the user.

16. A computer program product for browsing, the computer program product comprising a computer readable storage medium having program instructions embodied therewith, the program instructions executable by a computer to cause the computer to perform a method comprising:
receiving a selection by a user of a particular summary entry from a set of summary entries displayed by an information hub, each of the summary entries being a respective summary of a respective detailed entry from a set of detailed entries accessible from different ones of a plurality of destination applications;
generating, by a hardware processor, metadata information about related detailed entries to the particular information summary entry selected by the user; and
generating a custom view for a display device, the custom view including the respective detailed entry for the particular information summary selected by the user and suggestions of related detailed entries determined from the set of detailed entries using the metadata information.

17. The computer program product of claim 16, wherein the suggestions of related detailed entries are included in the custom view as respective ones of the summary entries for the related detailed entries.

18. The computer program product of claim 16, further comprising dynamically updating the custom view responsive to real-time user interactions relating to the summary entries and the detailed entries.

19. The computer program product of claim 16, wherein at least one of the related detailed entries is sourced from a different one of the plurality of destination applications than the respective detailed entry for the particular information summary selected by the user.

20. A system for browsing, comprising:
a computing device, having a processor, a memory, and a display device, configured to:
receive a selection by a user of a particular summary entry from a set of summary entries displayed by an information hub, each of the summary entries being a respective summary of a respective detailed entry from a set of detailed entries accessible from different ones of a plurality of destination applications;
generate metadata information about related detailed entries to the particular information summary entry selected by the user; and
generate a custom view for the display device, the custom view including the respective detailed entry for the particular information summary selected by the user and suggestions of related detailed entries determined from the set of detailed entries using the metadata information.
